(19) United States
(12) Patent Application Publication
(10) Pub. No.: US 2006/0153410 A1
(43) Pub. Date: Jul. 13, 2006

(54) Apparatus and method for moisture controlin an enclosure for e.g. loudspeakers

(76) Inventor: Mark Alexander Dodd, Suffolk (GB)

Correspondence Address: Myers Dawes;Andras & Sherman, 11th Floor, 19900 MacArthur Boulevard, Irvine, CA, 92612, US

(21) Appl. No.: 10/530,120

(22) PCT Filed: Oct. 2, 2003
(86) PCT No.: PCT/GB03/04276

§ 371 Date: Oct. 11, 2005

(30) Foreign Application Priority Data
Oct. 2, 2002 (GB) 0222759.3

(51) Int. Cl. H04R 1/02

(52) U.S. Cl. 381/334; 381/345

(57) ABSTRACT

A loudspeaker or other enclosure 10 constituting a humidity sensitive region the moisture of which is to be reduced contains a heater 18A. The tube 12 having a bore narrow enough to prevent diffusion of gases therethrough leads from the enclosure 10. The heater is operated cyclically by a switching circuit 19 to heat the interior of the enclosure to expel moist air through the tube 12 and thereby control the humidity of the air in the enclosure. A dessicant 16 may be provided in the tube 12. A heater 18B may be provided in the tube instead of in the enclosure.

This invention relates to apparatus for and methods of controlling moisture in an enclosure, and is particularly, but not exclusively, concerned with controlling the moisture in the enclosure or cabinet of an electroacoustic apparatus such as a loudspeaker.

It has long been known that the acoustic characteristics of a loudspeaker are affected by the relative humidity in the cabinet. For example, in GB-A-2146871 methods are described of using a moisture barrier to prevent moisture from entering the enclosure of a loudspeaker.

In WO-A-03/013183 there is described the use of adsorbent material, within a loudspeaker cabinet, which is at least partially hydrophobic, to repel moisture and increase the acoustic compliance of the acoustic enclosure. However, the effectiveness of this is dependent inter alia on the relative humidity of the air or gas within the enclosure, i.e. the amount of moisture present.

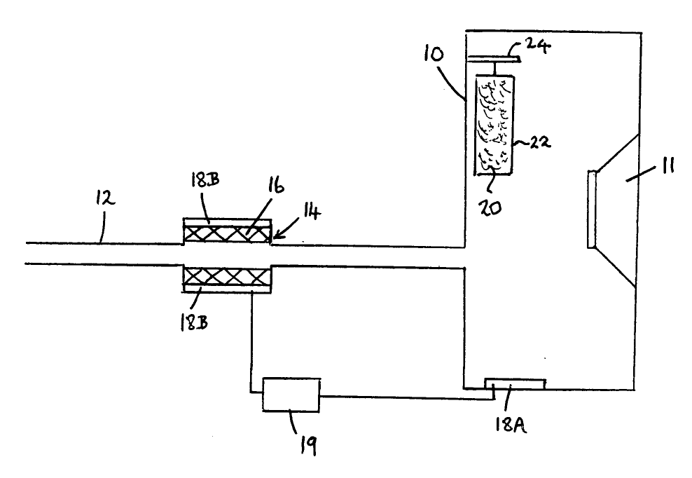

EP-A-0401495 shows in FIG. 1 an enclosure for holding controllers for electric power switches. The enclosure has two ventilation openings and an internal electrical heater. The ventilation openings are through horizontal slots of substantial cross-sectional area.

GB-A-2289752 describes a clothes dryer having two electrical blowers which respectively draw ambient air into a drying chamber and expel moisture-laden air from the cabinet. The incoming air is heated in a heat exchanger through which expelled air also passes. Again, the air flow is through openings of substantial cross-sectional area.

It is an object of the present invention to control the moisture within an enclosure which constitutes a humidity sensitive region. This includes, but is not limited to, loudspeaker enclosures.

It is another object of the present invention to provide means for and methods of reducing the moisture within an enclosure which constitutes a humidity sensitive region, such as a loudspeaker cabinet.

Broadly in accordance with the invention this is achieved by providing a heat source in or in communication with the enclosure and arranging that air or gas within the enclosure, when the heat source is operative, will pass out of the enclosure and entrain moisture therewith, the passage means comprising a tube having a bore narrow enough substantially to prevent diffusion of gases therethrough in the absence of a pressure differential between the interior of the enclosure and the ambient atmosphere.

The invention also provides a method of controlling the moisture in an enclosure which constitutes a humidity sensitive region, which comprises heating the gases within the enclosure or in gaseous communication therewith by a heat source, and providing, when the heat source is operative, for the outward movement of gases from the enclosure through a bore narrow enough substantially to prevent diffusion of gases therethrough in the absence of a pressure differential between the interior of the enclosure and the ambient atmosphere.

The narrow bore therefore substantially prevents unwanted diffusion of moist air into the enclosure from the ambient atmosphere when the pressures inside and outside the enclosure are substantially equalised, yet allows moist air to be expelled by the action of the heat source.

The system functions essentially as a pump to remove moisture from the enclosure by using thermal expansion of air to produce a net flow of moisture out of the interior of the enclosure and taking advantage of the increased moisture content of warmer air.

The tube preferably has a length of from about 50 to about 2000 mm, more preferably from about 100 to about 1000 mm, still more preferably from about 200 to about 800 mm and most preferably about 500 mm.

The tube may be linear or may be coiled, curved or otherwise non-linear, as desired.

The cross-sectional area of the tube, or at its narrowest point is preferably from about 0.8 to about 180 mm², more preferably from about 3 to about 180 mm², still more preferably from about 12 to about 50 mm² and, most preferably, about 30 mm².

In any particular enclosure, the length and cross-sectional area can be chosen with regard to the volume of the enclosure. In general, the greater the volume, the greater the length and/or the cross-sectional area should be.

When the enclosure is a loudspeaker, the invention also provides a loudspeaker enclosure which constitutes a humidity sensitive region and whose moisture content is arranged to be reduced by providing within the enclosure and/or in gaseous communication therewith a heat source, the enclosure comprising passage means to enable the outward movement of gases therefrom when the heat source is operative; and, further a method of controlling the moisture in a loudspeaker enclosure which constitutes a humidity sensitive region, which comprises heating the gases within the enclosure or in gaseous communication therewith by a heat source, and providing for the outward movement of gases from the enclosure when the heat source is operative.

Preferably, the heat source is switched on and off cyclically, conveniently at intervals of hours. In the case of a loudspeaker enclosure, into which moisture from the ambient atmosphere enters slowly, it may be necessary to switch the heat source “on” only every 3 to 4 hours for example.

The heat source can be of any suitable form. For example, one or more electrical resistors may be used, with an associated switching circuit.

The arrangement may include a dessicant for drying the outgoing air.

Advantageously, particularly in the case of a loudspeaker enclosure, the enclosure includes an adsorbent material which is or has been treated to make it at least partially hydrophobic.

While the apparatus and method has or will be described for the sake of grammatical fluidity with functional explanations, it is to be expressly understood that, when this specification is interpreted under United States law, the claims, unless expressly formulated under 35 USC 112, are not to be construed as necessarily limited in any way by the construction of “means” or “steps” limitations, but are to be accorded the full scope of the meaning and equivalents, and in the case where the claims are expressly formulated under 35 USC 112 are to be accorded full statutory equivalents under 35 USC 112.

In order that the invention may be more fully understood, an embodiment in accordance with the invention will now be described by way of example and with reference to the accompanying drawing which is a schematic diagram not to scale of a moisture controlled enclosure in accordance with the invention.

Many alterations and modifications may be made by those having ordinary skill in the art without departing from the spirit and scope of The invention. Therefore, it must be understood that the illustrated embodiment has been set forth only for the purposes of example and that they should not be taken as limiting the invention as defined by the following claims. For example, notwithstanding the fact that the elements of a claim are set forth below in a certain combination, it must be expressly understood that the invention includes other combinations of fewer, more or different elements, which are disclosed herein even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims therefore include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claim subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilised. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

Referring to the drawing, there is shown an enclosure 10 which constitutes a humidity sensitive region and which contains air and/or gas or gases. In the case where the enclosure 10 is a loudspeaker cabinet, loudspeaker units and/or other electroacoustic devices 11 will be present in the enclosure. In such a case, the ambient air will gradually leak into the enclosure, for example via the loudspeakers, and if the relative humidity of the ambient air is high, then the moisture content within the enclosure will increase, adversely affecting the acoustic characteristics.

A tube 12 with a bore which is narrow enough to prevent the diffusion of gases therethrough in a steady-state condition is in communication with the enclosure 10. Although the tube 12 is shown as being external to the enclosure, it could alternatively be positioned physically within the enclosure, or partially within the enclosure. Part way along the length of the tube 12 is a zone 14 which holds a dessicant 16. Again, regardless of the location of the tube 12, the dessicant 16 could alternatively be located within the enclosure. As shown, the tube 12 acts as a moisture trap. The tube has a circular bore of about 6 mm, corresponding to a cross-sectional area of about 28 mm² and a length of about 500 mm.

At least one heat source, for example, a resistive circuit, is provided to heat the air/gas/water vapour in the enclosure 10 or in the passage/zone 14 which is in communication with the enclosure.

The heat source could be provided in the enclosure, as indicated at 18A, or at the dessicant 16, as indicated at 18B. Alternatively, more than one heat source could be provided, for example one in the enclosure and one in the moisture trap. Under most circumstances the moisture can be adequately controlled by a cyclic operation of the heat source, for example at intervals of a few hours, e.g. 3 to 4 hours. This is suitably controlled automatically, by the use of a switching circuit 19. The heat generated by the heat source or sources will cause an expansion of the gases within the enclosure and there will be a passage of gases outwardly from the enclosure via the tube 12, entraining water vapour.

The cabinet may contain an absorbent material 20 which is or has been treated to make it at least partially hydrophobic. The material 20 may be contained in a tube 22 of a multi-filament textile material suspended from a support arm 24. A suitable material is that disclosed in WO-A-03/013183, the entire contents of which are incorporated herein by reference.

It has been found that the arrangement described above can operate to maintain a relative humidity of 50% within a loudspeaker enclosure which is positioned in an ambient environment of 85% relative humidity.

Although the invention has been described with particular reference to loudspeakers, it is to be understood that it is applicable to any enclosure which constitutes a humidity sensitive region and where one wishes to control the moisture within that enclosure.

The present invention may be embodied in other specific forms without departing from the spirit or essential attributes thereof and, accordingly, reference should be made to the appended claims, rather than to the foregoing specification, as indicating the scope of the invention.

1. A loudspeaker enclosure which constitutes a humidity sensitive region and whose moisture content is arranged to be reduced by providing within the enclosure and/or gaseous communication therewith a heat source, the enclosure comprising passage means to enable the outward movement of gases therefrom when the heat source is operative.

2. An enclosure which constitutes a humidity sensitive region and whose moisture content is arranged to be reduced by providing within the enclosure and/or in gaseous communication therewith a heat source, the enclosure comprising passage means to enable the outward movement of gases therefrom when the heat source is operative, the passage means comprising a tube having a bore narrow enough substantially to prevent diffusion of gases therethrough in the absence of a pressure differential between the interior of the enclosure and the ambient atmosphere.

3. The enclosure according to claim 2, wherein the enclosure comprises a loudspeaker enclosure.

4. The enclosure according to claim 2, in which the heat source comprises one or more electrical resistors.

5. The enclosure according to claim 2, in which the heat source is cyclically operative.

6. The enclosure according to claim 5, in which the heat source is cycled at intervals of hours.

7. The enclosure according to claim 2, further comprising a dessicant.

8. The enclosure according to claim 2, further comprising an adsorbent material which is or which has been treated to make it at least partially hydrophobic.

9. A method of controlling the moisture in a loudspeaker enclosure which constitutes a humidity sensitive region, comprising:
heating the gases within the enclosure or in gaseous communication therewith by a heat source; and
providing for the outward movement of gases from the enclosure when the heat source is operative.

10. A method of controlling the moisture in an enclosure which constitutes a humidity sensitive region, comprising:
heating the gases within the enclosure or in gaseous communication therewith by a heat source; and
providing, when the heat source is operative, for the outward movement of gases from the enclosure through a bore narrow enough substantially to prevent diffusion of gases therethrough in the absence of a pressure differential between the interior of the enclosure and the ambient atmosphere.

11. The method according to claim 10, wherein the enclosure comprises a loudspeaker enclosure.

12. The method according to claim 10, in which the heat source is cyclically operative.

13. The enclosure according to claim 1, in which the heat source comprises one or more electrical resistors.

14. The enclosure according to claim 1, in which the heat source is cyclically operative.

15. The enclosure according to claim 14, in which the heat source is cycled at intervals of hours.

16. The enclosure according to claim 1, further comprising a dessicant.

17. The enclosure according to any claim 1, further comprising an adsorbent material which is or which has been treated to make it at least partially hydrophobic.

18. The method according to claim 9, in which the heat source is cyclically operative.
